(19) United States
(12) Patent Application Publication
(10) Pub. No.: US 2024/0098549 A1
(43) Pub. Date: Mar. 21, 2024

(54) WI-FI MESH BACKHAUL LINK TX BIASING FOR BETTER END-TO-END THROUGHPUT AND DELAY

(71) Applicant: Qualcomm Incorporated, San Diego, CA (US)

(72) Inventors: Xiaolong HUANG, Santee, CA (US); Manish Shukla, Milpitas, CA (US); Srinivas Katar, Fremont, CA (US); Sandip Homchaudhuri, San Jose, CA (US); Simon Jan Brand, Pleasanton, CA (US); Harinder Singh, Saratoga, CA (US); Tejaswini Gollamudi, San Jose, CA (US); Qinfang Sun, Cupertino, CA (US)

(21) Appl. No.: 17/934,155

(22) Filed: Sep. 21, 2022

(51) Int. Cl. H04W 28/02

(52) U.S. Cl. CPC H04W 28/0231; H04W 84/12

(57) ABSTRACT

Aspects of the present disclosure allow for improving E2E mesh throughput by applying transmission (TX) biasing on the Wi-Fi mesh backhaul. Aspects of the disclosure are directed to solutions for reducing traffic load in Wi-Fi mesh networks by applying TX biasing on the Wi-Fi mesh backhaul. Certain aspects are directed to selectively transmitting or preventing transmission of data over the first backhaul link to the first MLD based at least in part on a fronthaul airtime utilization, a first backhaul airtime utilization, or a second backhaul airtime utilization. Doing so allows a root access point or a network controller to apply TX biasing between multi-link operation links towards each repeater so that traffic load on a backhaul-link would not overly occupy the front-haul link because of common channel use by selectively transmitting or preventing transmission of data on the backhaul links.

### TECHNICAL FIELD

The present disclosure generally relates to communication systems, and more particularly, to a wireless communication system between an access point (AP) and a repeater.

### INTRODUCTION

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Network nodes can be used to form a wireless mesh network. One characteristic of a mesh network is that there are generally multiple paths through the network that a given user or client may employ to reach the access point. One example of a mesh network is an 802.11 access mesh. If a set of clients in a close geographical proximity are equipped with 802.11 cards, they can communicate with other clients in a series of hops until reaching an AP of the mesh network. Typically, the AP is connected to a fixed network using a point-to-point link such as an optical fiber, copper loop, or via another wireless transmission. Due to latency and system complexity the number of wireless router hops is typically kept to some maximum, for example six. This limits the area of coverage of a wireless mesh network to a “cluster” or neighborhood community, the clusters being connected to the fixed network via the access points. Additional access points may be added to reduce the number of hops between clients and APs, and hence to reduce latency and an amount of occupied bandwidth on the mesh.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the subject matter described in this disclosure can be implemented in an apparatus for wireless communication. The apparatus may be an AP. The apparatus includes a memory and at least one processor coupled to the memory. The processor is configured to receive a report indicating a fronthaul airtime utilization in a first frequency band of a fronthaul link between a first multi-link device (MLD) and a network entity. The processor is also configured to determine a first backhaul airtime utilization in the first frequency band of a first backhaul link between the apparatus and the first MLD, and a second backhaul airtime utilization in a second frequency band of a second backhaul link between the apparatus and the first MLD. The apparatus may be in a second MLD. The processor is also further configured to selectively transmit or prevent transmission of data over the first backhaul link to the first MLD based at least in part on the fronthaul airtime utilization, the first backhaul airtime utilization, or the second backhaul airtime utilization.

In another aspect, the subject matter described in this disclosure can be implemented in a method for wireless communication at an AP. The method includes receiving a report indicating a fronthaul airtime utilization in a first frequency band of a fronthaul link between a first multi-link device (MLD) and a network entity. The method also includes determining a first backhaul airtime utilization in the first frequency band of a first backhaul link between the AP and the first MLD, and a second backhaul airtime utilization in a second frequency band of a second backhaul link between the AP and the first MLD. The AP may be in a second MLD. The method further includes selectively transmit or prevent transmission of data over the first backhaul link to the first MLD based at least in part on the fronthaul airtime utilization, the first backhaul airtime utilization, or the second backhaul airtime utilization.

In another aspect, the subject matter described in this disclosure can be implemented in an apparatus for wireless communication. The apparatus may be a station (STA) or an AP serving as a repeater or relay. The apparatus includes a memory and at least one processor coupled to the memory. The processor is configured to transmit a report indicating a fronthaul airtime utilization in a first frequency band of a fronthaul link between the apparatus and a network entity. The apparatus may be in a first MLD, and the network entity may be a client device such as a user equipment (UE). The processor is further configured to selectively receive or prevent reception of data over a first backhaul link between the apparatus and a second MLD based at least in part on the fronthaul airtime utilization, or a first backhaul airtime utilization in the first frequency band of the first backhaul link.

In another aspect, the subject matter described in this disclosure can be implemented in a method of wireless communication at a first network entity. The first network entity may be a station (STA) or an AP serving as a repeater or relay. The method includes receiving a report indicating a fronthaul airtime utilization in a first frequency band of a fronthaul link between the first network entity and a second network entity. The first network entity may be in a first MLD, and the second network entity may be a client device such as a UE. The method further includes selectively receiving or preventing reception of data over a first backhaul link between the apparatus and a second MLD based at least in part on the fronthaul airtime utilization, or a first backhaul airtime utilization in the first frequency band of the first backhaul link.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating hardware aspects of an access point (AP) and two stations (STAs).

FIG. 3 is a diagram illustrating an example of an end-to-end (E2E) throughput impacted by an interference of a backhaul link with a fronthaul link.

FIG. 4 is a diagram illustrating an example of a mesh network statistics.

FIG. 5 illustrates a call flow diagram between an access point and a repeater.

FIG. 6 illustrates an example flowchart illustrating a method of wireless communication at an AP.

FIG. 7 illustrates an example flowchart illustrating a method of wireless communication at an AP.

FIG. 8 illustrates an example flowchart illustrating a method of wireless communication at a repeater.

FIG. 9 illustrates an example flowchart illustrating a method of wireless communication at a repeater.

FIG. 10 is a diagram illustrating an example of extending transmission (TX) biasing on multi-link operations (MLO) links to a multi-repeater mesh.

FIG. 11 illustrates an example flow chart illustrating a method of wireless communication.

FIG. 12 illustrates an example flow chart illustrating method of wireless communication.

FIG. 13 shows a block diagram of an example wireless communication device.

FIG. 14A shows a block diagram of an example AP.

FIG. 14B shows a block diagram of an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Wi-Fi multi-link operations (MLO) may increase aggregate capacity for a standalone Basic Service Set (BSS) by utilizing both MLO links. However, in a Wi-Fi mesh, when a transmission (TX) of a repeater on a backhaul link overlaps in frequency band of the TX on its fronthaul link, using both MLO links on the backhaul may reduce the End-to-End (E2E) throughput. Thus, it would be helpful if there was a way to reduce traffic load on the backhaul link that interferes with the fronthaul link when multiple backhaul links are not a bottleneck for supplying the E2E traffic.

Aspects of the present disclosure allow for improving E2E mesh throughput by reducing traffic load on backhaul links that interfere with a fronthaul link (e.g., by selectively transmitting or preventing transmission of data on the backhaul links). Aspects of the present disclosure may apply TX biasing on the Wi-Fi mesh backhaul. Doing so allows a root access point or a network controller to apply TX biasing between multi-link operation links towards each repeater so that traffic load on a backhaul link would not overly occupy the fronthaul link because of common channel use. Thus, to improve E2E mesh throughput, a TX biasing may be applied to the Wi-Fi mesh backhaul.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

MLO technology may aggregate multiple channels on different frequency bands at the same time by negotiating seamless network traffic even if there is interference or congestion. Accordingly, MLO may greatly increase speeds, allow more effective mesh networks, and provide late interference mitigation techniques to ensure wireless devices are always connected fast and reliably. For instance, Wi-Fi MLO may increase aggregate capacity for a standalone BSS by utilizing both MLO links. However, in a Wi-Fi mesh network when the TX of a repeater on a back-haul link overlaps in frequency band of the TX on its front-haul link, using both MLO links on the backhaul may reduce the E2E throughput. Thus, it would be helpful to determine if in-network interference is limiting E2E throughput across each repeater and apply TX biasing between the MLO links if the multi-link backhaul has sufficient capacity to supply the E2E traffic to the fronthaul link.

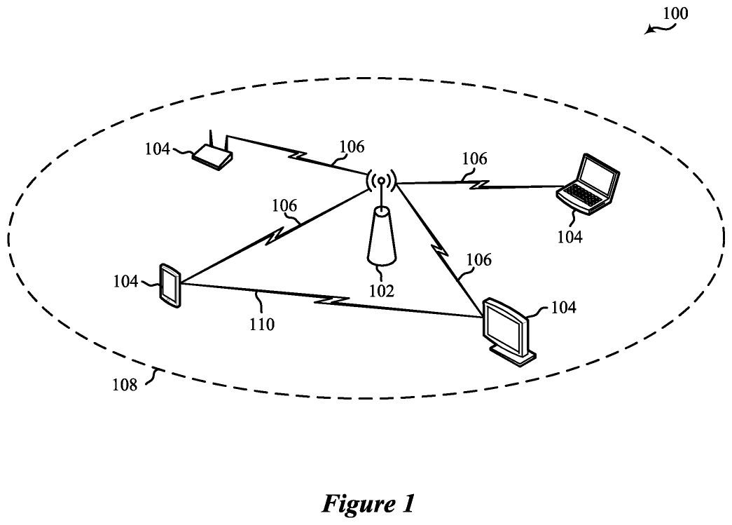

FIG. 1 is a network schematic illustrating an example wireless communication network 100. According to some aspects, the wireless communication network 100 can be an example of a wireless local area network (WLAN) such as a Wi-Fi network (and will hereinafter be referred to as wireless communication network 100). For example, the wireless communication network 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba, and 802.11be). The wireless communication network 100 may include numerous wireless communication devices such as an access point (AP) 102 and multiple stations (STAs) 104. While only one AP 102 is shown, the wireless communication network 100 also can include multiple APs 102 (e.g., multiple APs that are part of an AP multi-link device (MLD)).

Certain aspects of the disclosure may relate to multi-link operation (MLO) communications between wireless MLDs. Each MLD may have a unique medium access control (MAC) address, which is also referred to as a MAC service access point (MAC-SAP) endpoint. One example of an MLD device is an AP MLD 102, which includes multiple APs each capable of communicating on one of multiple communication links and establishing a basic service set (BSS) on the multiple communication links. Another example of an MLD device is a STA MLD 104 (e.g., a non-AP MLD), which includes multiple STAs capable of communicating with other devices (such as an AP MLD 102) on multiple communication links. The STA MLD 104 may have one medium access control physical layer (MAC-PHY) instance for each of the multiple communication links, and the MAC address of each MAC-PHY instance may be the same or different.

Each of the STAs 104 also may be referred to as a mobile station (MS), a mobile device, a mobile handset, a wireless handset, an access terminal (AT), a user equipment (UE), a subscriber station (SS), a non-AP MLD, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified to users by a service set identifier (SSID), as well as to other devices by a basic service set identifier (BSSID), which may be a medium access control (MAC) address of the AP 102. The AP 102 periodically broadcasts beacon frames including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the wireless communication network 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the wireless communication network 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

Each of the frequency bands may include multiple subchannels or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

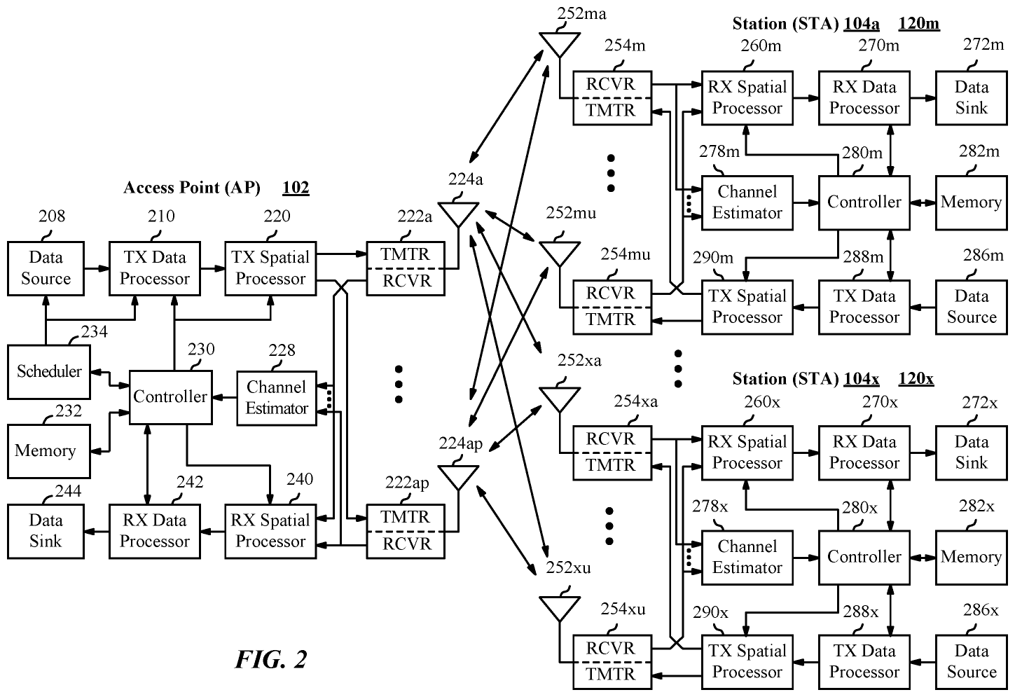

FIG. 2 illustrates a block diagram of an AP 102 and two STAs 104a and 104x in a BSS. The AP 102 is equipped with Nₜ antennas 224a through 224ap. STA 120m is equipped with N_{ut,m} antennas 252ma through 252mu, and STA 120x is equipped with N_{ut,x} antennas 252xa through 252xu. The AP 102 is a transmitting entity for the downlink and a receiving entity for the uplink. Each STA 104 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each STA 104 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the AP 102.

Nup STAs may be scheduled for simultaneous transmission on the uplink. Each of these STAs performs spatial processing on its data symbol stream and transmits its set of transmit symbol streams on the uplink to the AP 102.

At the AP 102, Nₐₚ antennas 224a through 224ap receive the uplink signals from all Nup STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at AP 102, a TX data processor 210 receives traffic data from a data source 208 for Ndn STA scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides Ndn downlink data symbol streams for the Ndn STA. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STA.

At each STA 120, N_{ut,m} antennas 252 receive the Nₐₚ downlink signals from AP 102. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each STA typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each STA may send feedback information (e.g., the downlink and/or uplink eigenvectors, eigenvalues, SNR estimates, and so on) to the access point. Controllers 230 and 280 also control the operation of various processing units at AP 102 and STA 104, respectively.

The devices (e.g., APs 102 and STAs 104) may create an ad-hoc network (e.g., mesh network) using wireless signaling to exchange information regarding the WAN/WLAN mobile environment. A mesh network may include a number of APs 102 joined together to connect one or more clients or STAs 104 to a WAN, such as the Internet. One or more APs 102 may include a wired backhaul connection the WAN.

A mesh network may be created by establishing radio links between the number of APs 102. The radio links may be implemented with any suitable wireless protocol including, by way of example, IEEE 802.11 (Wi-Fi), IEEE 802.20 (Wi-Max), Bluetooth, Ultra Wideband (UWB), or any other wireless protocol having any suitable underlying air interface. Examples of air interfaces include Orthogonal Frequency-Division Multiple Access (OFDMA), Wideband Code Division Multiple Access (W-CDMA), and the like. Moreover, various concepts disclosed throughout this disclosure may be extended wide area networks employing various wireless protocols including, by way of example, CDMA2000, Global System for Mobile Communications (GSM), Ultra Mobile Broadband (UMB), Enhanced Data rates for GSM Evolution (EDGE), etc. The specific wireless protocol used for any mesh network will vary depending on the specific application and the overall design constraints imposed on the overall system.

Reducing traffic load among MLO links in a mesh network is of primary importance for improving E2E mesh throughput and quality of service (QoS) for communications. For instance, Wi-Fi MLO may increase aggregate capacity for a standalone BSS by utilizing both MLO links.

However, in a Wi-Fi mesh network, when the TX of a repeater on a backhaul link overlaps in frequency band of the TX on its fronthaul link, using both MLO links on the backhaul can reduce the E2E throughput. Accordingly, applying TX biasing on the Wi-Fi mesh network may reduce traffic load on the backhaul link that interferes with the fronthaul link (e.g., by selectively transmitting or preventing transmission of data on the backhaul links) when the multiple backhaul links together is not a bottleneck for supplying the E2E traffic.

Aspects of the disclosure are directed to solutions for reducing traffic load in Wi-Fi mesh networks by applying TX biasing on the Wi-Fi mesh backhaul. In an example, under heavy backhaul traffic load, based on in-network interference impact on E2E throughput across each repeater, if the multi-link backhaul has sufficient capacity to supply the E2E traffic to the fronthaul, a root AP (or a network controller) is configured to apply TX biasing between the MLO links towards each repeater so that the traffic load on a backhaul link does not overly occupy the fronthaul link because of common channel usage. In another example, under light backhaul traffic load, the root AP (or the network controller) is configured to apply TX biasing such that the traffic is directed to a preferred band link (e.g., a 6 GHz frequency band) to leave the remaining channel open (e.g., a 5 GHz frequency band) for non-TX bias capable STAs in the mesh network and only utilize both MLO links when the traffic demands become high.

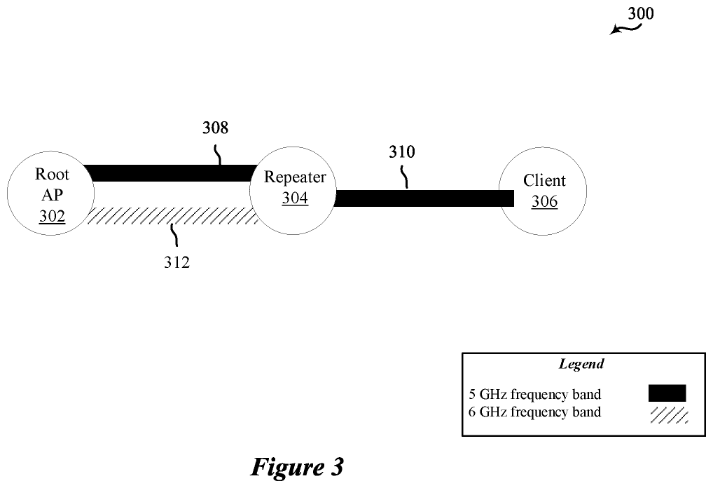

FIG. 3 illustrates an example 300 of an E2E throughput impacted by an interference of a backhaul link with a fronthaul link. In example 300, a repeater 304 has a first backhaul link 308 on a 5G frequency band in a 240 MHz bandwidth with a root AP 302, a second backhaul link 312 on a 6G frequency band in a 320 MHz bandwidth with the root AP 302, and a first fronthaul link 310 on the 5G frequency band in a 160 MHz bandwidth with a client 306. In this example 300, the bottleneck is not on the two backhaul links 308, 312. Instead, the bottleneck is on the first fronthaul link 310.

In addition, the TX of the repeater 304 on the backhaul link 308 overlaps in frequency band (e.g., 5G) of the TX on its fronthaul link 310. Accordingly, since the bottleneck is on the first fronthaul link 310 (and not on the first backhaul link 308 and the second backhaul link 312), traffic may be reduced by using both the first backhaul link 308 and the second backhaul link 312 to reduce the E2E throughput.

The root AP 302 (or a network controller) may be configured to determine if in-network interference is limiting E2E throughput across each repeater 304. The root AP 302 may also be configured to determine if the other band has sufficient capacity to serve all traffic without using the remaining band to interfere with non-TX bias capable STAs.

Under heavy backhaul traffic load, based on in-network interference impact on E2E throughput across each repeater, if the multi-link backhaul 308, 312 has sufficient capacity to supply the E2E traffic to the fronthaul link 310, the root AP 302 (or the network controller) applies TX biasing between the MLO links 308, 312 towards each repeater 304 such that the traffic load on a backhaul link 308 would not overly occupy the fronthaul link 310 because of their common channel usage. For a heavy backhaul load TX biasing, there may be a few options to limit the packet release on a backhaul MLO link 308 to limit the airtime occupation on one backhaul link 308, while fully utilizing the other backhaul link 312. Moreover, the backhaul link TX biasing may need to be applied per-repeater per-backhaul band.

Under light backhaul traffic load, the root AP 302 (or the network controller) applies TX biasing such that the traffic goes to a preferred band link (e.g., the 6G band) hence leaving the remaining channel entirely open for the non-TX bias capable STAs in the mesh network, and only utilizing both MLO links 308, 312 when the traffic demands become high.

Although not pictured, example 300 may also include a second fronthaul link on the 6G frequency band in a 320 MHz bandwidth with the client 306. Alternatively, also not pictured, example 300 may also include a second fronthaul link on the 6G 320 frequency to an additional client.

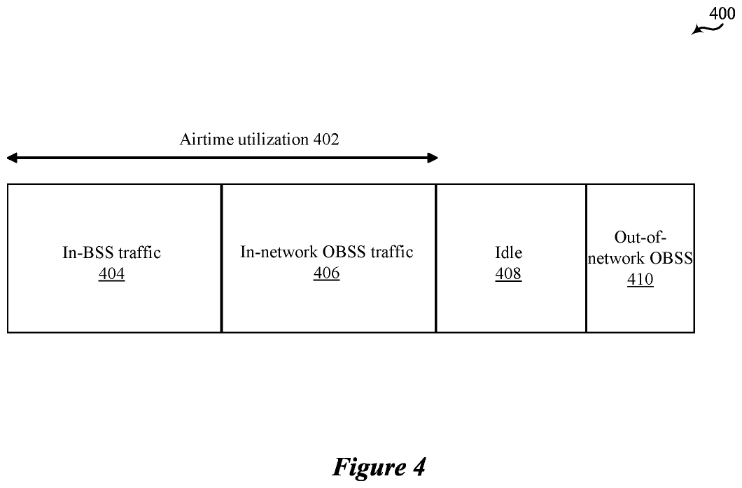

FIG. 4 illustrates an example 400 of mesh network statistics used for determining airtime utilization 402. A mesh controller may collect mesh network statistics related to airtime utilization 402 to determine if in-network interference is limiting E2E throughput across a repeater.

Airtime utilization 402 refers to how much time is available on a channel for data transmissions. Anytime a device communicates with another device or an AP, it uses airtime. Airtime utilization 402 is a per-channel statistic that defines what percentage of the channel is currently being used, and what percentage is therefore free. As an example, airtime usage may come from data traffic to and from client devices, interference from Wi-Fi and non-Wi-Fi sources, or management overhead from APs and client. Specifically, the mesh controller may collect the airtime utilization 402 composition of each fronthaul band from each repeater and the airtime utilization composition of each backhaul band from the root AP. For example, referring to FIG. 3, a mesh controller may collect airtime utilization composition of each fronthaul band 310 from each repeater 304 and the airtime utilization composition of each backhaul band 308, 312 from the root AP 302. The root AP may include the mesh controller, or the mesh controller may be located in a server or elsewhere than the root AP.

In this example, a mesh network statistics report may include at least an in network basic service set (In-BSS) traffic 404 airtime percentage, an in-network overlapping basic service set (OBSS) traffic 406 airtime percentage, an idle time 408 airtime percentage, and an out-of-network OBSS 410 traffic airtime percentage. For example, referring to FIG. 3, the In-BSS traffic 404 airtime percentage may correspond to measurements of the backhaul link 308 from the root AP 302 perspective. For example, referring to FIG. 3 again, the OBSS traffic 406 airtime percentage corresponds to measurements of the fronthaul link 310 from the root AP 302 perspective. Non-TX bias capable STA traffic may be included in the OBSS 410 traffic airtime percentage.

Accordingly, the mesh network statistics may help a root AP determine whether the In-BSS traffic 404 or OBSS traffic interfere or each other. For example, referring to FIG. 3, the root AP 302 may determine whether the In-BSS traffic on the backhaul link 308 or OBSS traffic on the front haul link 310 are issues for each other. If there is a lot of idle time 408, then the interference may not be considered an issue. However, if the In-BSS traffic 404 and the idle time 408 are positioned close to the out-of-network OBSS 410 then there may be no more airtime. For instance, the percentage of idle time is minimized such that the total percentage of In-BSS traffic 404 and In-network OB SS traffic 406 accounts for nearly the entire remainder of the total utilization not occupied by the out-of-network OBSS 410.

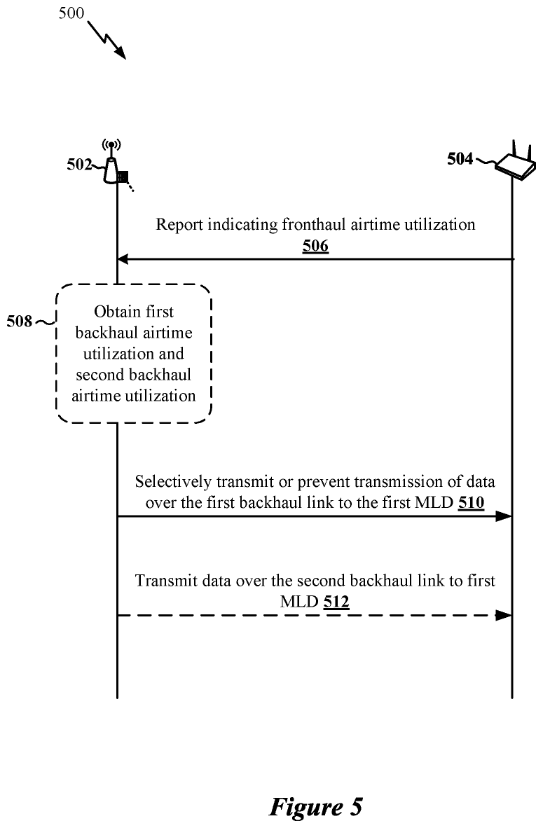

FIG. 5 is a call flow 500 diagram between a root AP 502 and a repeater 504. A call flow 500 illustrates an exemplary sequence of operations performed between the root AP 502 and the repeater 504. For example, call flow 500 depicts operations for applying TX biasing on the Wi-Fi mesh backhaul link by selectively transmitting or preventing transmission of data on the backhaul links. It is understood that one or more of the operations described in call flow 500 may be performed earlier or later in the process, omitted, replaced, supplemented, or combined with another operation. Also, additional operations described herein that are not included in call flow 500 may be included in call flow 500.

The root AP 502 may correspond to AP 102, 302, 1402. The repeater 504 may correspond to STA 104, 120, apparatus 1404, or another AP 102, 302, 1402. The repeater may be in a first MLD, and the root AP may be in a second MLD.

Initially, the root AP 502 may be configured to receive a report indicating fronthaul airtime utilization 506 using mesh network statistics. For example, referring to FIG. 4, the fronthaul airtime utilization 402 may be determined using the mesh network statistics shown in example 400.

The root AP 502 may also be configured to determine a first backhaul airtime utilization in the first frequency band of a first backhaul link between the root AP 502 and the repeater 504, and a second backhaul airtime utilization in a second frequency band of a second backhaul link 508 between the root AP 502 and the repeater 504. For example, referring to FIG. 3, the root AP 302 may obtain a first backhaul airtime utilization in the first frequency band of a first backhaul link 308 between the root AP 302 and the repeater 304, and a second backhaul airtime utilization in a second frequency band of a second backhaul link 312 between the root AP 302 and the repeater 304.

The root AP 502 may further be configured to selectively transmit or prevent transmission of data over the first backhaul link to the first MLD based at least in part on the fronthaul airtime utilization, or the first backhaul airtime utilization. In an aspects, when the root AP 502 prevents an initial transmission of data over the first backhaul link to the first MLD based at least in part on the fronthaul airtime utilization, the root AP 502 may delay the transmission of data by transmitting the data at a subsequent time (e.g., when there is less contention). For instance, a schedule delay may be applied on the backhaul link of the congestion towards the repeater. In another instance, the packet transmission may be selectively scheduled on the MLO link of the congestion towards the repeater. For example, referring back to FIG. 3, the root AP 302 may selectively transmit or prevent transmission of data over the first backhaul link 308 to the repeater 304 based at least in part on the fronthaul airtime utilization, the first backhaul airtime utilization, or the second backhaul airtime utilization.

In some aspects, the root AP 502 may be further configured to transmit the data over the second backhaul link to the first MLD For example, referring back again to FIG. 3, the root AP 302 may transmit the data over the second backhaul link 312 to the repeater 304.

In this way, E2E mesh throughout may be improved by applying TX biasing on the Wi-Fi mesh backhaul. Accordingly, the root AP 502 may obtain airtime utilization statistics in the different frequency bands to determine whether in-network interference is limiting E2E throughout across the repeater. If a first active fronthaul band airtime utilization exceeds an airtime utilization threshold then TX biasing may be applied to both backhaul links toward the repeater to reduce traffic load on the backhaul link that interferes with the fronthaul link. In some aspects, the airtime utilization threshold may be 90% and up to 100%.

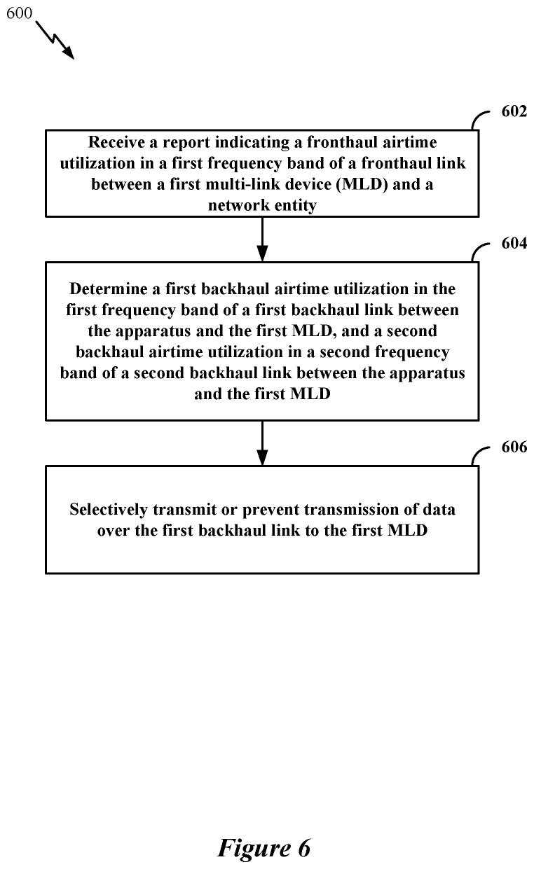

FIG. 6 illustrates an example flowchart illustrating a method 600 of wireless communication at an access point. The method 600 may be performed by or at an apparatus (e.g., the AP 102, 302, 502), another wireless communication apparatus (e.g., the WCD 1300, the AP 1402), or one or more components thereof. According to various different aspects, one or more of the illustrated methods 600 may be omitted, transposed, and/or contemporaneously performed. This method 600 allows for applying TX biasing on the Wi-Fi mesh backhaul.

The method 600 may be performed by an apparatus, such as the WCD 1300 or AP 1402, as described below. In some implementations, the method 600 is performed by processing logic, including hardware, firmware, software, or a combination thereof. In some implementations, the method 600 is performed by a processor executing code stored in a non-transitory computer-readable medium (e.g., a memory).

At operation 602, the apparatus is configured to receive a report indicating a fronthaul airtime utilization in a first frequency band of a fronthaul link between a first MLD and a network entity. In an aspect, the apparatus may be a root AP, the network entity may be a UE, and the first MLD may comprise a repeater. For example, referring back to FIGS. 3-5, the apparatus 302, 502 may receive the report indicating a fronthaul airtime utilization 506, in a first frequency band (e.g., a 5G band) of a fronthaul link 310 between a first MLD (e.g., repeater 304, 504) and a network entity (e.g., client 306) from the repeater 304, 504. In another example, referring to FIG. 4, the fronthaul airtime utilization 402 may be determined based on monitoring mesh network statistics listed in example 400.

In an aspect, the report may comprise: an in network basic service set (BSS) traffic airtime percentage, an overlapping basic service set (OBSS) traffic airtime percentage, an idle airtime percentage, and a station (STA) traffic load. The apparatus may be configured to selectively transmit or prevent transmission of the data over the first backhaul link to the first MLD based at least in part on the BSS traffic airtime percentage, the OBSS traffic airtime percentage, the idle airtime percentage, and the STA traffic load. For example, referring to FIG. 4, the report may comprise In-BSS traffic 404, In-network OBSS traffic 406, an idle time 408, and an out of network OBSS 410. In an aspect, the report may comprise a second fronthaul airtime utilization in the second frequency band (e.g., a 6G band) of a second fronthaul link between the first MLD and the network entity or a second network entity (e.g., a same or different client).

At operation 604, the apparatus is also configured to determine a first backhaul airtime utilization in the first frequency band of a first backhaul link between the apparatus and the first MLD, and a second backhaul airtime utilization in a second frequency band of a second backhaul link between the apparatus and the first MLD. The apparatus may be in a second MLD. For example, referring to FIGS. 3-5, the AP 502 may obtain the first backhaul airtime utilization 402 in the first frequency band (e.g., the 5G band) of a first backhaul link 308 between the apparatus (e.g., AP 502) and the first MLD (e.g., repeater 304, 504), and the second backhaul airtime utilization in a second frequency band (e.g., the 6G band) of a second backhaul link 312 between the apparatus (e.g., AP 502) and the first MLD (e.g., repeater 304, 504).

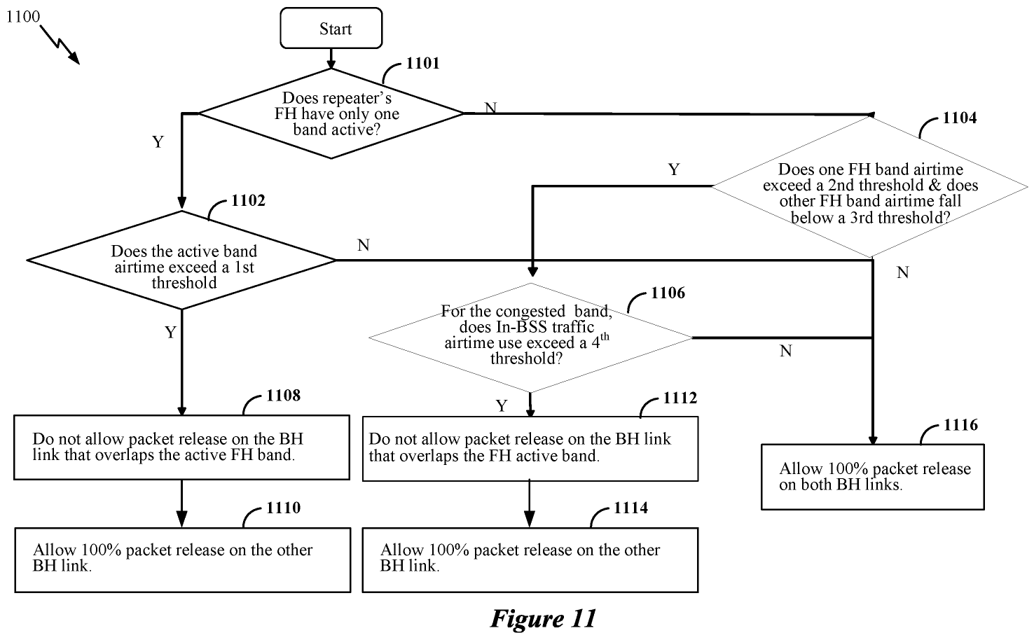

At operation 606, the apparatus may further be configured to selectively transmit or prevent transmission of data over the first backhaul link to the first MLD based at least in part on the fronthaul airtime utilization, or the first backhaul airtime utilization. For example, referring back to FIGS. 3 and 5, the AP (root AP 302, 502) may selectively transmit or prevent transmission of the data over the first backhaul link 308 to the first MLD (repeater 304,504). More details of this aspect are described below with respect to FIG. 11 (e.g., at block 1112).

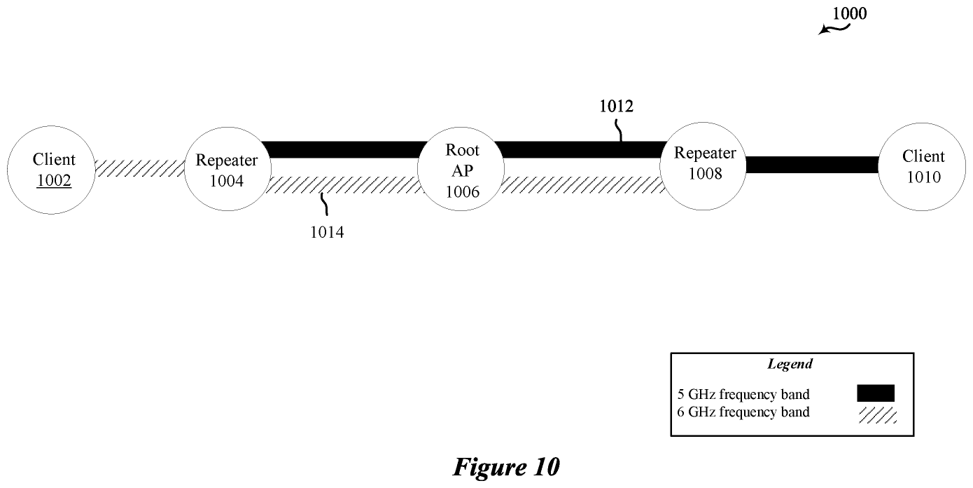

In an aspect, the data may be transmitted over the first backhaul link to the first MLD in response to a difference between: a first total airtime utilization of the first fronthaul airtime utilization and the first backhaul airtime utilization, and a second total airtime utilization of: a third fronthaul airtime utilization in the second frequency band of a third fronthaul link between a third MLD and a second network entity, and a third backhaul airtime utilization in the second frequency band of a third backhaul link between the apparatus and the third MLD exceeding a first threshold, and based at least in part the first fronthaul airtime utilization in the first frequency band exceeding a second threshold, wherein the second total airtime utilization is a maximum total airtime utilization in the second frequency band for a plurality of MLDs including the third MLD. More details of this aspect are described below with respect to FIG. 10.

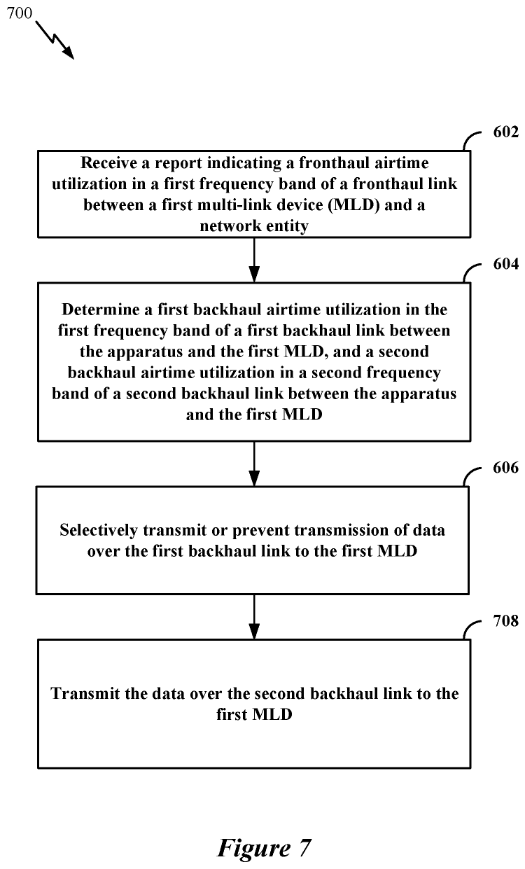

FIG. 7 illustrates an example flowchart illustrating a method of wireless communication at an access point. The method 700 may be performed by or at an apparatus (e.g., the AP 502, 302, 102), another wireless communication apparatus (e.g., the WCD 1300, or AP 1402), or one or more components thereof. According to various different aspects, one or more of the illustrated methods 700 may be omitted, transposed, and/or contemporaneously performed. This method 700 allows for applying TX biasing on the Wi-Fi mesh backhaul.

The method 700 may be performed by an apparatus, such as the WCD 1300 or the AP 1402, as described below. In some implementations, the method 700 is performed by processing logic, including hardware, firmware, software, or a combination thereof. In some implementations, the method 700 is performed by a processor executing code stored in a non-transitory computer-readable medium (e.g., a memory). In the method 700, operation 602, 604, and 606 are performed as described above in connection to FIG. 6.

At operation 708, the apparatus may further be configured transmit the data over the second backhaul link to the first MLD. For example, referring back to FIGS. 3 and 5, the AP 302, 502 may transmit the data over the second backhaul link 312 to the first MLD (e.g., repeater 304, 504). In some aspects, the apparatus may be further configured to transmit the data over the first backhaul link to the first MLD based at least in part on the first fronthaul airtime utilization in the first frequency band falling below a first threshold or the second fronthaul airtime utilization in the second frequency band exceeding a second threshold. More details of this aspect are described below with respect to FIG. 11 (e.g., at block 1116).

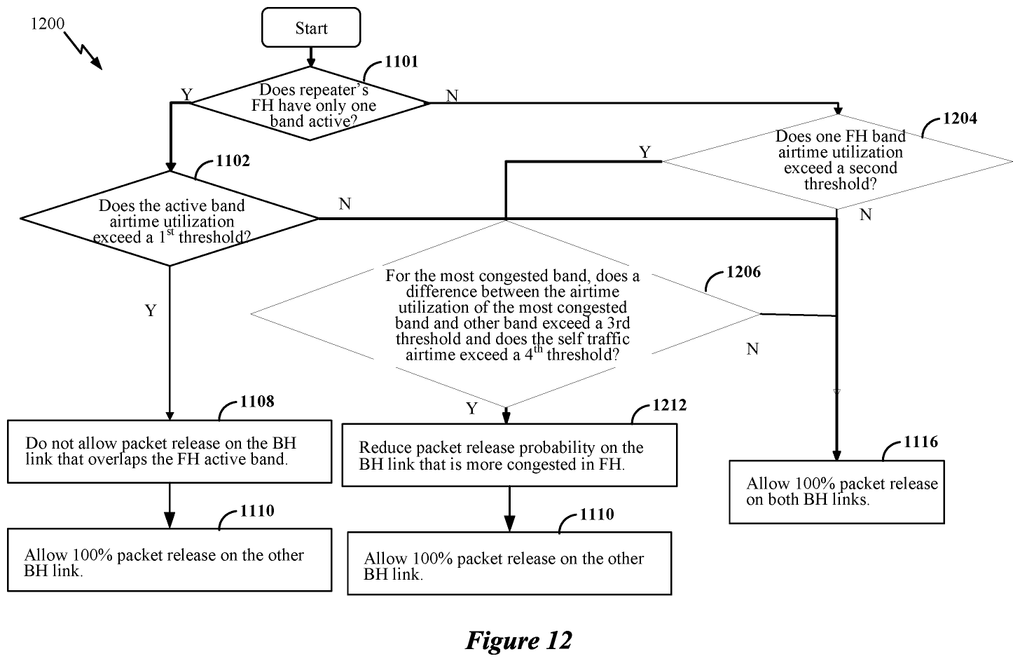

In an aspect, the apparatus may be further configured to reduce an amount of the data transmitted over the backhaul link to the first MLD based at least in part on the fronthaul airtime utilization in the first frequency band exceeding a first threshold (e.g., as described below in FIG. 11 or 12 respectively at blocks 1104 or 1204). In an aspect, the apparatus may be further configured to transmit the data over the second backhaul link to the first MLD. In an aspect, the apparatus may be configured to transmit data over the first backhaul link to the first MLD and an amount of the data transmitted is reduced based at least in part on: for a most congested band from the first frequency band and the second frequency band, a difference between a backhaul airtime utilization in the most congested band and a backhaul airtime utilization in a least congested band from the first frequency band and the second frequency band exceeding a fourth threshold, and the first backhaul airtime utilization in the most congested band exceeding a fifth threshold (e.g., as described below in FIG. 12 at block 1206).

In an aspect, the apparatus may be configured to transmit the data over the second backhaul link to the first MLD, and the apparatus is configured to transmit the data over the first backhaul link to the first MLD based at least in part on the first fronthaul airtime utilization in the first frequency band falling below a first threshold (e.g., as described below in FIG. 11 or 12 respectively at block 1116).

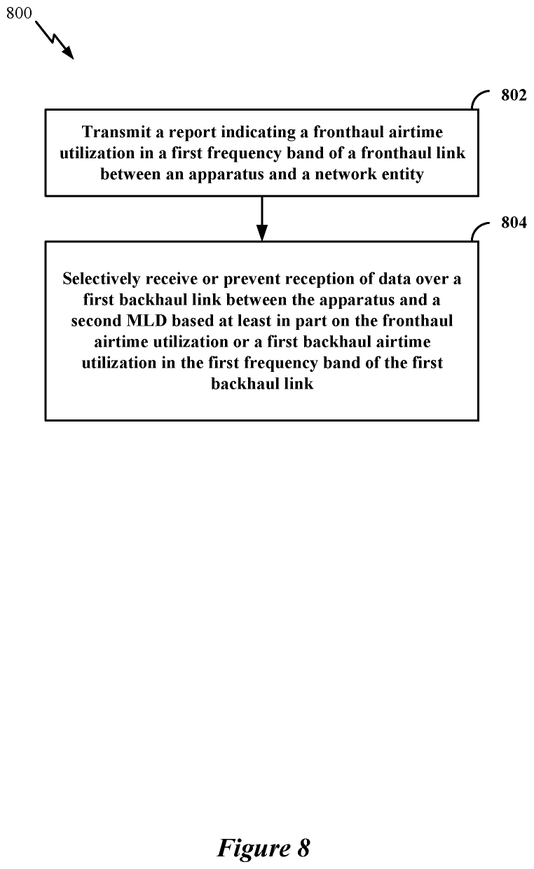

FIG. 8 illustrates an example flowchart illustrating a method of wireless communication at a repeater. The method 800 may be performed by or at an apparatus (e.g., the repeater 504, 304), another wireless communication apparatus (e.g., the apparatus 1404), or one or more components thereof. According to various different aspects, one or more of the illustrated methods 800 may be omitted, transposed, and/or contemporaneously performed. This method 800 allows for applying TX biasing on the Wi-Fi mesh backhaul.

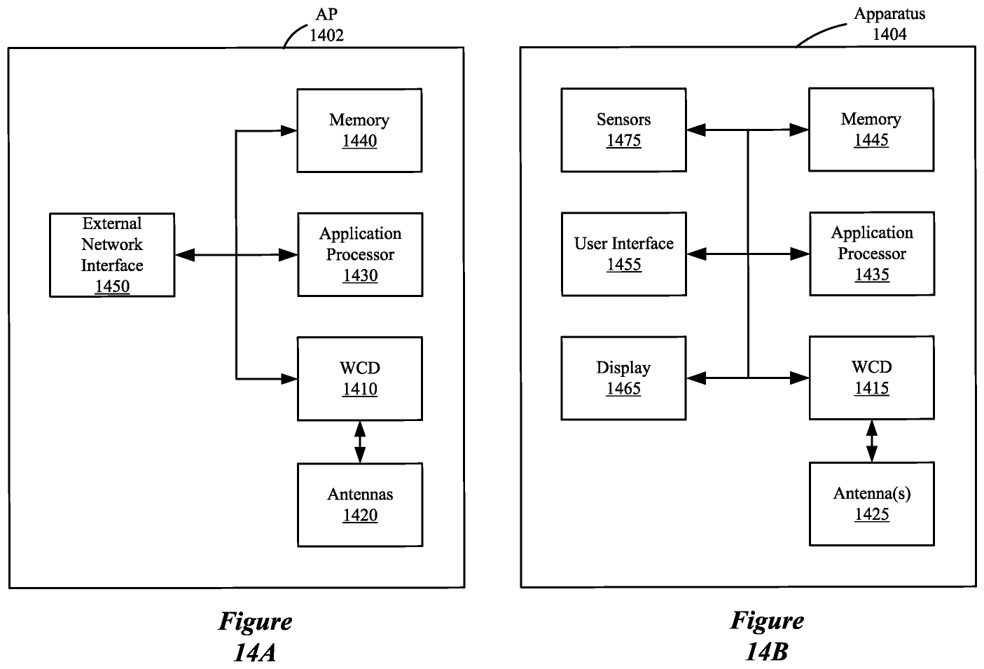

The method 800 may be performed by an apparatus, such as apparatus 1404 from FIG. 14B, as described below. In some implementations, the method 800 is performed by processing logic, including hardware, firmware, software, or a combination thereof. In some implementations, the method 800 is performed by a processor executing code stored in a non-transitory computer-readable medium (e.g., a memory).

At operation 802, the apparatus is configured to transmit a report indicating a fronthaul airtime utilization in a first frequency band of a fronthaul link between an apparatus and a network entity. The apparatus may be in a first MLD. In an aspect, the apparatus comprises a station (STA) or an AP serving as a repeater or relay, the network entity is a user equipment (UE), and the first MLD comprises a root access point (AP). For example, referring to FIGS. 3-5, the apparatus (e.g., repeater 304, 504) may transmit the report indicating a front airtime utilization 506 in a first frequency band of a fronthaul link 310. In another example, referring to FIG. 4, the fronthaul airtime utilization 402 may be determined based on monitoring mesh network statistics.

In an aspect, the report may comprise: an in network basic service set (BSS) traffic airtime percentage, an overlapping basic service set (OBSS) traffic airtime percentage, an idle airtime percentage, and a station (STA) traffic load. The at least one processor may be configured to selectively receive or prevent reception of the data over the first backhaul link to the first MLD based at least in part on the BSS traffic airtime percentage, the OBSS traffic airtime percentage, the idle airtime percentage, and the STA traffic load. For example, referring to FIG. 4, the report may comprise In-BSS traffic 404, In-network OBSS traffic 406, an idle time 408, and an out of network OBSS 410 traffic.

In an aspect, the report may comprise a second fronthaul airtime utilization in the second frequency band of a second fronthaul link between the first MLD and the network entity or a second network entity. The at least one processor may be further configured to determine the first backhaul airtime utilization in the first frequency band of the first backhaul link and the second backhaul link airtime utilization in the second frequency band of the second backhaul link based on the first MLD being connected to the network entity or the second network entity with the second fronthaul link.

At operation 804, the apparatus may further be configured to selectively receive or prevent reception of data over a first backhaul link between the apparatus and a second MLD based at least in part on the fronthaul airtime utilization, or a first backhaul airtime utilization in the first frequency band of the first backhaul link. For example, referring to FIGS. 3-5, the apparatus 304, 504 may selectively receive or prevent reception of the data over the first backhaul link 308 from the first MLD 302.

In an aspect, the apparatus may be configured to prevent reception of the data over the first backhaul link between the apparatus and the entity based at least in part on the fronthaul airtime utilization in the first frequency band exceeding a first threshold and the second fronthaul airtime utilization in the second frequency band falling below a second threshold (e.g., as described below at FIG. 11 with respect to blocks 1104 and 1112). In an aspect, the apparatus may be configured to prevent reception of the data over the first backhaul link to the first MLD based at least in part on the first backhaul airtime utilization in the first frequency band exceeding a third threshold (e.g., as described below at FIG. 11 further with respect to block 1106).

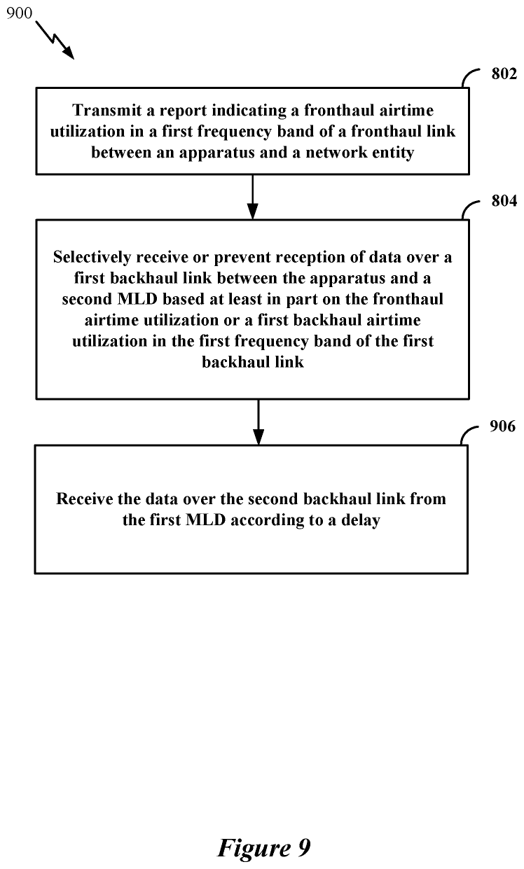

FIG. 9 illustrates an example flowchart illustrating a method of wireless communication at an access point. The method 900 may be performed by or at an apparatus (e.g., the repeater 504, 304), another wireless communication apparatus (e.g., the apparatus 1404), or one or more components thereof. According to various different aspects, one or more of the illustrated methods 900 may be omitted, transposed, and/or contemporaneously performed. This method 600 allows for applying TX biasing on the Wi-Fi mesh backhaul.

The method 900 may be performed by an apparatus, such apparatus 1404 from FIG. 14B, as described below. In some implementations, the method 800 is performed by processing logic, including hardware, firmware, software, or a combination thereof. In some implementations, the method 900 is performed by a processor executing code stored in a non-transitory computer-readable medium (e.g., a memory). In the method 900, operation 802 and 804 are performed as described above in connection to FIG. 8.

At operation 906, the apparatus may further be configured receive the data over the second backhaul link from the first MLD. For example, referring back to FIGS. 3 and 5, the apparatus (e.g., repeater 304, 504) may receive the data over the second backhaul link 312 to the first MLD (e.g., root AP) 302, 304.

In some aspects, the apparatus may be further configured to receive the data over the second backhaul link from the first MLD and to receive the data over the first backhaul link between the apparatus and the entity based at least in part on the first fronthaul airtime utilization in the first frequency band falling below a first threshold or in response to the second fronthaul airtime utilization in the second frequency band exceeding a second threshold (e.g., at block 1116 of FIG. 11).

In an aspect, in the apparatus may be configured to receive the data over the second backhaul link from the first MLD and to receive the data over the first backhaul link to the first MLD based at least in part on the first fronthaul airtime utilization in the first frequency band falling below a first threshold (e.g., at block 1116 of FIG. 11 or 12).

In an aspect, the apparatus may be configured to reduce an amount of the data received over the first backhaul link between the apparatus and the entity based at least in part on the fronthaul airtime utilization in the first frequency band exceeding a first threshold. In an aspect, the apparatus may be configured to receive the data over a first backhaul link between the apparatus and a second MLD and an amount of the data received is reduced based at least in part on: for a most congested band from the first frequency band and the second frequency band, a difference between a backhaul airtime utilization in the most congested band and a backhaul airtime utilization in a least congested band from the first frequency band and the second frequency band exceeding a fourth threshold, and the first backhaul airtime utilization in the most congested band exceeding a fifth threshold (e.g., at block 1212 of FIG. 12).

FIG. 10 is a diagram illustrating an example of extending TX biasing on multi-link operations (MLO) links to a multi-repeater mesh. In example 1000, reducing traffic load on one backhaul link 1012 related to a first client 1010 would subsequently increase the traffic load on the other backhaul link 1014 which may negatively impact the E2E throughput of a second client 1002 whose bottleneck hop is operating on the other backhaul link.

To avoid having TX biasing on MLO links towards a repeater 1008 negatively impact the E2E throughout across another repeater 1004, the network controller may be configured to check all repeaters 1004, 1008 in a decreasing order from a most congested backhaul link to the least congested backhaul link. The network controller may also be configured to compare the airtime utilization between the link of most congested E2E path across the repeater to the most congested link of the most congested E2E path of another band of all repeaters. Accordingly, TX biasing is only applied if the most congested E2E path of one band had sufficiently higher airtime utilization (e.g., >20%) than that of the other band and has caused congestion on the fronthaul of some repeater.

FIG. 11 illustrates an example flow chart illustrating a method of wireless communication. The method 1100 may be performed by an apparatus, such as the AP 102 described with reference to FIG. 1, the root AP 302 described above with reference to FIG. 3, the root AP 502 shown in FIG. 5, a root AP 1006 shown in FIG. 10, the AP 1402 shown in FIG. 14A, as described below. In some implementations, the method 1100 is performed by processing logic, including hardware, firmware, software, or a combination thereof. In some implementations, the method 1100 is performed by a processor executing code stored in a non-transitory computer-readable medium (e.g., a memory). The method 1100 describes an “all or nothing approach” to limit packet release on a backhaul MLO link. For example, referring back to FIG. 3, the apparatus (e.g., root AP 302) may limit packet release on a backhaul MLO link 308. In another example, referring back to FIG. 5, the apparatus (e.g., AP 502) may transmit or prevent transmission of data over the first backhaul link to the first MLD 504.

As represented by block 1101, the method 1100 includes determining whether a repeater's fronthaul link has only one band active (e.g., if the repeater is only communicating with a client on one frequency band, such as illustrated in FIGS. 3 and 10). If it is determined that the repeater only has one band active (the “Yes” path), then, as represented by block 1101, the method 1100 includes determining whether the active band has an airtime utilization greater than or equal to a first airtime utilization threshold. In some instances, the first airtime utilization threshold may be 90% up to a 100%.

For example, referring to FIG. 4, the airtime utilization 402 may be determined based at least in part on In-BSS traffic 404, In-network OBSS traffic 406, Idle time 408, and out-of-network OBSS 410. If it is determined that the active band does not have an airtime utilization greater than or equal to the first airtime utilization threshold (the “No” path), then, as represented, by block 1116, the method 1100 includes allowing 100% packet release on both backhaul links. If it is determined that the active band has an airtime utilization greater than or equal to the first airtime utilization threshold (the “Yes” path), then, as represented, by block 1108, the method 1100 includes not allowing packet release on the backhaul link that overlaps the active fronthaul band. Next, as represented by block 1110, the method 1100 includes allowing 100% packet release on the other backhaul link.

If it is determined that the repeater does not only have one band active (the “No” path) (e.g., if the repeater is communicating with a client on both frequency bands), then, as represented by block 1104, the method 1100 includes determining whether one fronthaul band has an airtime utilization greater than or equal to a second airtime utilization threshold and whether the other fronthaul band has an airtime utilization less than a third airtime utilization threshold. In some instances, the second airtime utilization threshold may be 90% up to 100%. In some instances, the third airtime utilization threshold may be 20%. If it is determined that one fronthaul band does not have an airtime utilization greater than or equal to the second threshold or the other band does not have an airtime utilization that is less than the third airtime utilization threshold (the “No” path), then, as represented by block 1116, the method 1100 includes allowing 100% packet release on both backhaul links.

If it is determined that the one fronthaul has an airtime utilization that is greater than or equal to the second airtime utilization threshold and the other band has an airtime utilization that is less than a third airtime utilization threshold (the “Yes” path), then, as represented by block 1106, the method 1100 includes, for the congested band, determining whether the In-BSS traffic airtime use exceeds a fourth airtime utilization threshold. In some instances, the fourth airtime utilization threshold may be 15%. If it is determined that the In-BSS traffic airtime use exceeds the fourth airtime utilization threshold (the “No” path), then, as represented by block 1116, the method 1100 includes allowing 100% packet release on both backhaul links.

If it is determined that the In-BSS traffic airtime use does not exceed the fourth airtime utilization threshold (the “Yes” path), then, as represented by block 1112, the method 1100 includes not allowing packet release on the backhaul link that overlaps the fronthaul active band. Next, as represented by block 1114, the method 1100 includes allowing 100% packet release on the other backhaul link.

It should be understood that the percentage numbers and thresholds listed in method 1100 are non-limiting and are only used as examples to describe the method 1100.

FIG. 12 illustrates an example flow chart illustrating a method of wireless communication. The method 1200 may be performed by an apparatus, such as the AP 102 described with reference to FIG. 1, the root AP 302 described above with reference to FIG. 3, the root AP 602 shown in FIG. 5, the root AP 1006 shown in FIG. 10, the AP 1402 shown in FIG. 14A, as described below. In some implementations, the method 1200 is performed by processing logic, including hardware, firmware, software, or a combination thereof. In some implementations, the method 1200 is performed by a processor executing code stored in a non-transitory computer-readable medium (e.g., a memory). The method 1200 describes a “probabilistic approach” to limit packet release on a backhaul MLO link. For example, referring to FIG. 3, the apparatus 302 may limit packet release on a backhaul MLO link 308. In another example, referring to FIG. 5, the apparatus (e.g., AP 502) may selectively transmit or prevent transmission of data over the first backhaul link to the first MLD 504. In contrast to the “all or nothing approach” described in FIG. 11, where data is either transmitted or not transmitted, here in the “probabilistic approach” of FIG. 12, the data may be selectively transmitted. In the method 1200, blocks 1101, 1102, 1108, 1110, and 1112 are performed as described above in connection to FIG. 11.

As represented by block 1204, the method 1200 includes determining whether one fronthaul band airtime utilization exceeds a second threshold. In some examples, the second airtime utilization threshold may be 90% and up to 100%. For example, referring to FIG. 4, the airtime utilization 402 may be determined based at least in part on In-BSS traffic 404, In-network OBSS traffic 406, Idle time 408, and out-of-network OBSS 410. If is it determined that one fronthaul band airtime utilization is does not exceed the second airtime utilization threshold (the “No” path), then, as represented by block 1116, the method 1200 includes allowing 100% packet release on both backhaul links.

If it is determined that one fronthaul band airtime utilization does exceed the second airtime utilization threshold (the “Yes” path), then, as represented by block 1206, the method 1200 includes determining, for the most congested band, whether a difference between the airtime utilization of the most congested band and the other band exceed a third airtime utilization threshold and whether the self-traffic airtime use exceeds a fourth airtime utilization threshold. In some instances, the third airtime utilization threshold may be 20% and the fourth airtime utilization threshold may be 15%.

If it is determined that for the most congested band, the difference between the most congested band and the other band does not exceed a third airtime utilization threshold or the self-traffic airtime use does not exceed the fourth airtime utilization threshold (the “No” path), then, as represented by block 1116, the method 1200 includes allowing 100% packet release on both backhaul links.

If it is determined that, for the most congested band, the difference between airtime utilization of the most congested band and the other band exceeds the third airtime utilization threshold and the self-traffic airtime use exceeds the fourth threshold (the “Yes” path), then, as represented by block 1212, the method includes reducing packet release probability on the backhaul link that is more congested in fronthaul band. Next, as represented by block 1110, the method 1200 includes allowing 100% packet release on the other backhaul band.

It should be understood that the percentage numbers and thresholds listed in method 1200 are non-limiting and are only used as examples to describe the method 1200.

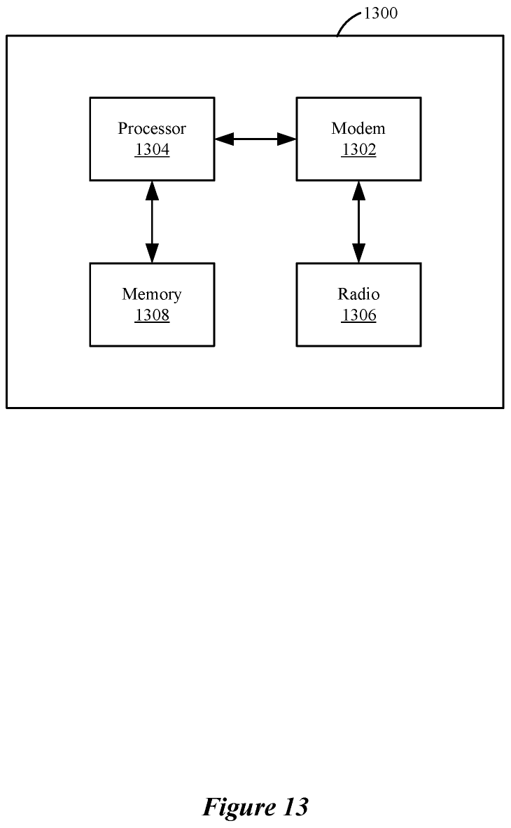

FIG. 13 shows a block diagram of an example wireless communication device 1300. In some aspects, the wireless communication device 1300 can be an example of a device for use in a STA such as one of the STAs 104 described with reference to FIG. 1. In some aspects, the wireless communication device 1300 can be an example of a device for use in an AP such as the AP 102 described above with reference to FIG. 1, the root AP 302 described above with reference to FIG. 3, the root AP 502 shown in FIG. 5, and the root AP 1006 shown in FIG. 10. The wireless communication device 1300 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 1300 can be, or can include, a chip, system on chip (SoC), chipset, package or device that includes one or more modems 1302, for example, a Wi-Fi (IEEE 802.11 compliant) modem. In some aspects, the one or more modems 1302 (collectively “the modem 202”) additionally include a WWAN modem (for example, a 3GPP 4G LTE or 5G compliant modem). In some aspects, the wireless communication device 1300 also includes one or more processors, processing blocks or processing elements 1304 (collectively “the processor 1304”) coupled with the modem 1302. In some aspects, the wireless communication device 1300 additionally includes one or more radios 1306 (collectively “the radio 1306”) coupled with the modem 1302. In some aspects, the wireless communication device 1300 further includes one or more memory blocks or elements 1308 (collectively “the memory 1308”) coupled with the processor 1304 or the modem 1302.

The modem 1302 can include an intelligent hardware block or device such as, for example, an application-specific integrated circuit (ASIC) among other possibilities. The modem 1302 is generally configured to implement a PHY layer, and in some aspects, also a portion of a MAC layer (for example, a hardware portion of the MAC layer). For example, the modem 1302 is configured to modulate packets and to output the modulated packets to the radio 1306 for transmission over the wireless medium. The modem 1302 is similarly configured to obtain modulated packets received by the radio 1306 and to demodulate the packets to provide demodulated packets. In addition to a modulator and a demodulator, the modem 1302 may further include digital signal processing (DSP) circuitry, automatic gain control (AGC) circuitry, a coder, a decoder, a multiplexer and a demultiplexer. For example, while in a transmission mode, data obtained from the processor 1304 may be provided to an encoder, which encodes the data to provide coded bits. The coded bits may then be mapped to a number NSS of spatial streams for spatial multiplexing or a number NSTS of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 1306. In aspects involving beamforming, the modulated symbols in the respective spatial streams are precoded via a steering matrix prior to their provision to the IFFT block.

While in a reception mode, the DSP circuitry is configured to acquire a signal including modulated symbols received from the radio 1306, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 1304) for processing, evaluation or interpretation.

The radio 1306 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some aspects, the wireless communication device 1300 can include, or be coupled with, multiple transmit antennas (each with a corresponding transmit chain) and multiple receive antennas (each with a corresponding receive chain). The symbols output from the modem 1302 are provided to the radio 1306, which then transmits the symbols via the coupled antennas. Similarly, symbols received via the antennas are obtained by the radio 1306, which then provides the symbols to the modem 1302.

The processor 1304 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 1304 processes information received through the radio 1306 and the modem 1302, and processes information to be output through the modem 1302 and the radio 1306 for transmission through the wireless medium. For example, the processor 1304 may implement a control plane and at least a portion of a MAC layer configured to perform various operations related to the generation, transmission, reception and processing of MPDUs, frames or packets. In some aspects, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some aspects, the processor 1304 may generally control the modem 1302 to cause the modem to perform various operations described above.

The memory 1308 can include tangible storage media such as random-access memory (RAM) or read-only memory (ROM), or combinations thereof. The memory 1308 also can store non-transitory processor- or computer-executable software (SW) code containing instructions that, when executed by the processor 1304, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

In one configuration, the wireless communication device 1300, and in particular the processor 1304, may include means for: receiving a report indicating a fronthaul airtime utilization in a first frequency band of a fronthaul link between a first multi-link device (MLD) and a network entity, determining a first backhaul airtime utilization in the first frequency band of a first backhaul link between an apparatus and the first MLD, and a second backhaul airtime utilization in a second frequency band of a second backhaul link between the apparatus and the first MLD, the apparatus being in a second MLD; and selectively transmitting or preventing transmission of data over the first backhaul link to the first MLD based at least in part on the fronthaul airtime utilization, the first backhaul airtime utilization, or the second backhaul airtime utilization.

FIG. 14A shows a block diagram of an example AP 1402. For example, the AP 1402 can be an example aspect of the AP 102 described with reference to FIG. 1, the root AP 302 described above with reference to FIG. 3, the root AP 502 shown in FIG. 5, and the root AP 1006 shown in FIG. 10. The AP 1402 includes a wireless communication device (WCD) 1410 (although the AP 1402 may itself also be referred to generally as a wireless communication device as used herein). For example, the WCD 1410 may be an example aspect of the wireless communication device 1300 described with reference to FIG. 13. The AP 1402 also includes multiple antennas 1420 coupled with the WCD 1410 to transmit and receive wireless communications. In some aspects, the AP 1402 additionally includes an application processor 1430 coupled with the WCD 1410, and a memory 1440 coupled with the application processor 1430. The AP 1402 further includes at least one external network interface 1450 that enables the AP 1402 to communicate with a core network or backhaul network to gain access to external networks including the Internet. For example, the external network interface 1450 may include one or both of a wired (for example, Ethernet) network interface and a wireless network interface (such as a WWAN interface). Ones of the aforementioned components can communicate with other ones of the components directly or indirectly, over at least one bus. The AP 1402 further includes a housing that encompasses the wireless communication device 1410, the application processor 1430, the memory 1440, and at least portions of the antennas 1420 and external network interface 1450.

FIG. 14B shows a block diagram of an example apparatus 1404. For example, the apparatus 1404 can be an example aspect of the STA 104 described with reference to FIG. 1, a repeater 304 described with reference to FIG. 3, a repeater 504 described with reference to FIG. 5, a repeater 1004, 1008 described with reference to FIG. 10.

The apparatus 1404 includes a wireless communication device (WCD) 1415 (although the apparatus 1404 may itself also be referred to generally as a wireless communication device as used herein). For example, the WCD 1415 may be an example aspect of the wireless communication device 1300 described with reference to FIG. 13. The apparatus 1404 also includes one or more antennas 1425 coupled with the WCD 1415 to transmit and receive wireless communications. The apparatus 1404 additionally includes an application processor 1435 coupled with the WCD 1415, and a memory 1445 coupled with the application processor 1435. In some aspects, the apparatus 1404 further includes a user interface (UI) 1455 (such as a touchscreen or keypad) and a display 1465, which may be integrated with the UI 1455 to form a touchscreen display. In some aspects, the apparatus 1404 may further include one or more sensors 1475 such as, for example, one or more inertial sensors, accelerometers, temperature sensors, pressure sensors, or altitude sensors. Ones of the aforementioned components can communicate with other ones of the components directly or indirectly, over at least one bus. The apparatus 1404 further includes a housing that encompasses the WCD 1415, the application processor 1435, the memory 1445, and at least portions of the antennas 1425, UI 1455, and display 1465.

In one configuration, the apparatus 1404, and in particular the application processor 1435, may include means for: transmit a report indicating a fronthaul airtime utilization in a first frequency band of a fronthaul link between the apparatus and a network entity, the apparatus being in a first MLD; and selectively receive or prevent reception of data over a first backhaul link between the apparatus and a second MLD based at least in part on the fronthaul airtime utilization, or a first backhaul airtime utilization in the first frequency band of the first backhaul link.

Aspects of the present disclosure allow for improving E2E mesh throughput by applying transmit (TX) biasing on the Wi-Fi mesh backhaul. Doing so allows a root access point or a network controller to apply TX biasing between multi-link operation links towards each repeater so that traffic load on a backhaul-link would not overly occupy the front-haul link because of common channel use.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### SOME ADDITIONAL EXAMPLES

The following example aspects are illustrative only and may be combined with aspects of other embodiments or teachings described herein, without limitation.

Aspect 1. An apparatus for wireless communication, comprising:
a memory; and
at least one processor coupled to the memory and configured to:
receive a report indicating a fronthaul airtime utilization in a first frequency band of a fronthaul link between a first multi-link device (MLD) and a network entity;
determine a first backhaul airtime utilization in the first frequency band of a first backhaul link between the apparatus and the first MLD, and a second backhaul airtime utilization in a second frequency band of a second backhaul link between the apparatus and the first MLD, the apparatus being in a second MLD; and
selectively transmit or prevent transmission of data over the first backhaul link to the first MLD based at least in part on the fronthaul airtime utilization, the first backhaul airtime utilization, or the second backhaul airtime utilization.

Aspect 2. The apparatus of aspect 1, The apparatus of claim 1, wherein the apparatus is a root access point (AP), the network entity is a user equipment (UE), and the first MLD comprises a repeater.

Aspect 3. The apparatus of aspects 1 or 2, wherein the report comprises: an in network basic service set (BSS) traffic airtime percentage, an overlapping basic service set (OBSS) traffic airtime percentage, an idle airtime percentage, and a station (STA) traffic load, wherein the at least one processor is configured to selectively transmit or prevent transmission of the data over the first backhaul link to the first MLD based at least in part on the BSS traffic airtime percentage, the OBSS traffic airtime percentage, the idle airtime percentage, and the STA traffic load.

Aspect 4. The apparatus of any of the aspects 1 to 3, wherein the report further comprises a second fronthaul airtime utilization in the second frequency band of a second fronthaul link between the first MLD and the network entity or a second network entity, wherein the at least one processor is configured to determine the first backhaul airtime utilization in the first frequency band of the first backhaul link and the second backhaul link airtime utilization in the second frequency band of the second backhaul link based on the first MLD being connected to the network entity or the second network entity with the second fronthaul link.

Aspect 5. The apparatus of any of the aspects 1 to 4, wherein the at least one processor is configured to prevent transmission of the data over the first backhaul link to the first MLD based at least in part on the fronthaul airtime utilization in the first frequency band exceeding a first threshold and the second fronthaul airtime utilization in the second frequency band falling below a second threshold.

Aspect 6. The apparatus of any of the aspects 1 to 5, wherein the at least one processor is further configured to: transmit the data over the second backhaul link to the first MLD.

Aspect 7. The apparatus of any of the aspects 1 to 6, wherein the at least one processor is configured to:
prevent transmission of the data over the first backhaul link to the first MLD further based at least in part on the first backhaul airtime utilization in the first frequency band exceeding a third threshold.

Aspect 8. The apparatus of any of the aspects 1 to 7, wherein the at least one processor is further configured to:
transmit the data over the second backhaul link to the first MLD according, and wherein the at least one processor is configured to transmit the data over the first backhaul link to the first MLD based at least in part on the first fronthaul airtime utilization in the first frequency band falling below a first threshold or the second fronthaul airtime utilization in the second frequency band exceeding a second threshold.

Aspect 9. The apparatus of any of the aspects 1 to 4, wherein the at least one processor is configured to:
reduce an amount of the data transmitted over the backhaul link to the first MLD based at least in part on the fronthaul airtime utilization in the first frequency band exceeding a first threshold.

Aspect 10. The apparatus of any of the aspects 1 to 9, wherein the at least one processor is further configured to:
transmit the data over the second backhaul link to the first MLD.

Aspect 11. The apparatus of any of the aspects 1 to 4 and 9-10, wherein the at least one processor is configured to: transmit the data over the first backhaul link to the first MLD and an amount of the data transmitted is reduced based at least in part on:
for a most congested band from the first frequency band and the second frequency band,
a difference between a backhaul airtime utilization in the most congested band and a backhaul airtime utilization in a least congested band from the first frequency band and the second frequency exceeding a fourth threshold, and
the first backhaul airtime utilization in the most congested band exceeding a fifth threshold

Aspect 12. The apparatus of aspect 4, wherein the at least one processor is further configured to:
transmit the data over the second backhaul link to the first MLD, and
wherein the at least one processor is configured to transmit the data over the first backhaul link to the first MLD based at least in part on the first fronthaul airtime utilization in the first frequency band falling below a first threshold.

Aspect 13. The apparatus of any of the aspects 1 to 12, wherein the data is transmitted over the first backhaul link to the first MLD based at least in part on a difference between:
a first total airtime utilization of the first fronthaul airtime utilization and the first backhaul airtime utilization, and
a second total airtime utilization of:
a third fronthaul airtime utilization in the second frequency band of a third fronthaul link between a third MLD and a second network entity, and
a third backhaul airtime utilization in the second frequency band of a third backhaul link between the apparatus and the third MLD,
   exceeding a first threshold, and in response to the first fronthaul airtime utilization in the first frequency band exceeding a second threshold,
   wherein the second total airtime utilization is a maximum total airtime utilization in the second frequency band for a plurality of MLDs including the third MLD

Aspect 14. An apparatus for wireless communication, comprising:
a memory; and
at least one processor coupled to the memory and configured to:
   transmit a report indicating a fronthaul airtime utilization in a first frequency band of a fronthaul link between the apparatus and a network entity, the apparatus being in a first MLD; and
selectively receive or prevent reception of data over a first backhaul link between the apparatus and a second MLD based at least in part on the fronthaul airtime utilization, or a first backhaul airtime utilization in the first frequency band of the first backhaul link.

Aspect 15. The apparatus of aspect 14, wherein the apparatus comprises a station (STA) or an AP serving as a repeater or relay, the network entity is a user equipment (UE), and the first MLD comprises a root access point (AP).

Aspect 16. The apparatus of aspects 14 or 15, wherein the report comprises: an in network basic service set (BSS) traffic airtime percentage, an overlapping basic service set (OBSS) traffic airtime percentage, an idle airtime percentage, and a station (STA) traffic load, wherein the at least one processor is configured to selectively receive or prevent reception of the data over the first backhaul link to the first MLD based at least in part on the BSS traffic airtime percentage, the OB SS traffic airtime percentage, the idle airtime percentage, and the STA traffic load.

Aspect 17. The apparatus of any of the aspects 14 to 16, wherein the report further comprises a second fronthaul airtime utilization in the second frequency band of a second fronthaul link between the first MLD and the network entity or a second network entity, wherein the at least one processor is further configured to determine the first backhaul airtime utilization in the first frequency band of the first backhaul link and the second backhaul link airtime utilization in the second frequency band of the second backhaul link based on the first MLD being connected to the network entity or the second network entity with the second fronthaul link.

Aspect 18. The apparatus of any of the aspects 14 to 17, wherein the at least one processor is configured to prevent reception of the data over the first backhaul link between the apparatus and the entity based at least in part on the fronthaul airtime utilization in the first frequency band exceeding a first threshold and the second fronthaul airtime utilization in the second frequency band falling below a second threshold.

Aspect 19. The apparatus of any of the aspects 14 to 18, wherein the at least one processor is further configured to:
receive the data over the second backhaul link to the first MLD.

Aspect 20. The apparatus of any of the aspects 14 to 19, wherein the at least one processor is further configured to prevent reception of the data over the first backhaul link to the first MLD based at least in part on the first backhaul airtime utilization in the first frequency band exceeding a third threshold.

Aspect 21. The apparatus of aspect 17, wherein the at least one processor is further configured to:
receive the data over the second backhaul link from the first MLD, and
wherein the at least one processor is configured to receive the data over the first backhaul link between the apparatus and the entity based at least in part on the first fronthaul airtime utilization in the first frequency band falling below a first threshold or the second fronthaul airtime utilization in the second frequency band exceeding a second threshold.

Aspect 22. The apparatus of any of the aspects 14 to 17, wherein the at least one processor is configured to: reduce an amount of the data received over the first backhaul link between the apparatus and the entity based at least in part on the fronthaul airtime utilization in the first frequency band exceeding a first threshold.

Aspect 23. The apparatus of any of the aspects 14 to 22, wherein the at least one processor is further configured to:
receive the data over the second backhaul link from the first MLD.

Aspect 24. The apparatus of any of the aspects 14 to 17 and 22 to 23, receive the data over a first backhaul link between the apparatus and a second MLD and an amount of the data received is reduced based at least in part on:
for a most congested band from the first frequency band and the second frequency band,
a difference between a backhaul airtime utilization in the most congested band and a backhaul airtime utilization in a least congested band from the first frequency band and the second frequency exceeding a fourth threshold, and
the first backhaul airtime utilization in the most congested band exceeding a fifth threshold.

Aspect 25. The apparatus of any of the aspects 14 to 17 and 22 to 24, wherein the at least one processor is further configured to:
receive the data over the second backhaul link from the first MLD, and
wherein the at least one processor is configured to receive the data over the first backhaul link to the first MLD based at least in part on the first fronthaul airtime utilization in the first frequency band falling below a first threshold.

Aspect 26. A method for wireless communication performed, comprising:
receiving a report indicating a fronthaul airtime utilization in a first frequency band of a fronthaul link between a first multi-link device (MLD) and a network entity;
determining a first backhaul airtime utilization in the first frequency band of a first backhaul link between an apparatus and the first MLD, and a second backhaul airtime utilization in a second frequency band of a second backhaul link between the apparatus and the first MLD, the apparatus being in a second MLD; and
selectively transmitting or preventing transmission of data over the first backhaul link to the first MLD based at least in part on the fronthaul airtime utilization, the first backhaul airtime utilization, or the second backhaul airtime utilization.

Aspect 27. The method of aspect 26, wherein the apparatus is a root access point (AP), the network entity is a user equipment (UE), and the first MLD comprises a repeater.

Aspect 28. The method of aspects 26 or 27, wherein the report further comprises a second fronthaul airtime utilization in the second frequency band of a second fronthaul link between the first MLD and the network entity or a second network entity, wherein determining the first backhaul airtime utilization in the first frequency band of the first backhaul link and the second backhaul link airtime utilization in the second frequency band of the second backhaul link is based on the first MLD being connected to the network entity or the second network entity with the second fronthaul link.

Aspect 29. A method for wireless communication, comprising:
transmitting a report indicating a fronthaul airtime utilization in a first frequency band of a fronthaul link between an apparatus and a network entity, the apparatus being in a first MLD;
and selectively receiving or preventing reception of data over a first backhaul link between the apparatus and a second MLD based at least in part on the fronthaul airtime utilization, or a first backhaul airtime utilization in the first frequency band of the first backhaul lin.

Aspect 30. The method of aspect 29, wherein the apparatus comprises a station (STA) or an AP serving as a repeater or relay, the network entity is a user equipment (UE), and the first MLD comprises a root access point (AP).

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive a report indicating a fronthaul airtime utilization in a first frequency band of a fronthaul link between a first multi-link device (MLD) and a network entity;
determine a first backhaul airtime utilization in the first frequency band of a first backhaul link between the apparatus and the first MLD, and a second backhaul airtime utilization in a second frequency band of a second backhaul link between the apparatus and the first MLD, the apparatus being in a second MLD; and
selectively transmit or prevent transmission of data over the first backhaul link to the first MLD based at least in part on the fronthaul airtime utilization, the first backhaul airtime utilization, or the second backhaul airtime utilization.

2. The apparatus of claim 1, wherein the apparatus is a root access point (AP), the network entity is a user equipment (UE), and the first MLD comprises a repeater.

3. The apparatus of claim 1, wherein the report comprises: an in network basic service set (BSS) traffic airtime percentage, an overlapping basic service set (OBSS) traffic airtime percentage, an idle airtime percentage, and a station (STA) traffic load, wherein the at least one processor is configured to selectively transmit or prevent transmission of the data over the first backhaul link to the first MLD based at least in part on the BSS traffic airtime percentage, the OBSS traffic airtime percentage, the idle airtime percentage, and the STA traffic load.

4. The apparatus of claim 1, wherein the report further comprises a second fronthaul airtime utilization in the second frequency band of a second fronthaul link between the first MLD and the network entity or a second network entity, wherein the at least one processor is configured to determine the first backhaul airtime utilization in the first frequency band of the first backhaul link and the second backhaul link airtime utilization in the second frequency band of the second backhaul link based on the first MLD being connected to the network entity or the second network entity with the second fronthaul link.

5. The apparatus of claim 4, wherein the at least one processor is configured to prevent transmission of the data over the first backhaul link to the first MLD based at least in part on the fronthaul airtime utilization in the first frequency band exceeding a first threshold and the second fronthaul airtime utilization in the second frequency band falling below a second threshold.

6. The apparatus of claim 5, wherein the at least one processor is further configured to:
transmit the data over the second backhaul link to the first MLD.

7. The apparatus of claim 5, wherein the at least one processor is configured to:
prevent transmission of the data over the first backhaul link to the first MLD further based at least in part on the first backhaul airtime utilization in the first frequency band exceeding a third threshold.

8. The apparatus of claim 4, wherein the at least one processor is further configured to:
transmit the data over the second backhaul link to the first MLD, and
wherein the at least one processor is configured to transmit the data over the first backhaul link to the first MLD based at least in part on a fronthaul airtime utilization in the first frequency band falling below a first threshold or the second fronthaul airtime utilization in the second frequency band exceeding a second threshold.

9. The apparatus of claim 4, wherein the at least one processor is configured to:
reduce an amount of the data transmitted over the first backhaul link to the first MLD based at least in part on the fronthaul airtime utilization in the first frequency band exceeding a first threshold.

10. The apparatus of claim 9, wherein the at least one processor is further configured to:
transmit the data over the second backhaul link to the first MLD.

11. The apparatus of claim 4, wherein the at least one processor is configured to:
transmit the data over the first backhaul link to the first MLD and an amount of the data transmitted is reduced based at least in part on:
for a most congested band from the first frequency band and the second frequency band,
a difference between a backhaul airtime utilization in the most congested band and a backhaul airtime utilization in a least congested band from the first frequency band and the second frequency band exceeding a fourth threshold, and
the first backhaul airtime utilization in the most congested band exceeding a fifth threshold.

12. The apparatus of claim 4, wherein the at least one processor is further configured to:
transmit the data over the second backhaul link to the first MLD, and
wherein the at least one processor is configured to transmit the data over the first backhaul link to the first MLD based at least in part on the fronthaul airtime utilization in the first frequency band falling below a first threshold.

13. The apparatus of claim 1, wherein the data is transmitted over the first backhaul link to the first MLD based at least in part on a difference between:
a first total airtime utilization of the fronthaul airtime utilization and the first backhaul airtime utilization, and
a second total airtime utilization of:
a third fronthaul airtime utilization in the second frequency band of a third fronthaul link between a third MLD and a second network entity, and
a third backhaul airtime utilization in the second frequency band of a third backhaul link between the apparatus and the third MLD,
the difference exceeding a first threshold, and based at least in part on the fronthaul airtime utilization in the first frequency band exceeding a second threshold,
wherein the second total airtime utilization is a maximum total airtime utilization in the second frequency band for a plurality of MLDs including the third MLD.

14. An apparatus for wireless communication, comprising:
a memory; and
at least one processor coupled to the memory and configured to:
transmit a report indicating a fronthaul airtime utilization in a first frequency band of a fronthaul link between the apparatus and a network entity, the apparatus being in a first MLD; and
selectively receive or prevent reception of data over a first backhaul link between the apparatus and a second MLD based at least in part on the fronthaul airtime utilization, a first backhaul airtime utilization in the first frequency band of the first backhaul link, or a second backhaul airtime utilization in a second frequency band of a second backhaul link between the apparatus and the second MLD.

15. The apparatus of claim 14, wherein the apparatus comprises a station (STA) or an AP serving as a repeater or relay, the network entity is a user equipment (UE), and the first MLD comprises a root access point (AP).

16. The apparatus of claim 14, wherein the report comprises: an in network basic service set (BSS) traffic airtime percentage, an overlapping basic service set (OBSS) traffic airtime percentage, an idle airtime percentage, and a station (STA) traffic load, wherein the at least one processor is configured to selectively receive or prevent reception of the data over the first backhaul link to the first MLD based at least in part on the BSS traffic airtime percentage, the OBSS traffic airtime percentage, the idle airtime percentage, and the STA traffic load.

17. The apparatus of claim 14, wherein the report further comprises a second fronthaul airtime utilization in the second frequency band of a second fronthaul link between the first MLD and the network entity or a second network entity, wherein the at least one processor is further configured to determine the first backhaul airtime utilization in the first frequency band of the first backhaul link and the second backhaul link airtime utilization in the second frequency band of the second backhaul link based on the first MLD being connected to the network entity or the second network entity with the second fronthaul link.

18. The apparatus of claim 17, wherein the at least one processor is configured to prevent reception of the data over the first backhaul link between the apparatus and the entity based at least in part on the fronthaul airtime utilization in the first frequency band exceeding a first threshold and the second fronthaul airtime utilization in the second frequency band falling below a second threshold.

19. The apparatus of claim 18, wherein the at least one processor is further configured to:
receive the data over the second backhaul link to the first MLD.

20. The apparatus of claim 18, wherein the at least one processor is further configured to prevent reception of the data over the first backhaul link to the first MLD based at least in part on the first backhaul airtime utilization in the first frequency band exceeding a third threshold.

21. The apparatus of claim 17, wherein the at least one processor is further configured to:
receive the data over the second backhaul link from the first MLD, and
wherein the at least one processor is configured to receive the data over the first backhaul link between the apparatus and the entity based at least in part on the fronthaul airtime utilization in the first frequency band falling below a first threshold or the second fronthaul airtime utilization in the second frequency band exceeding a second threshold.

22. The apparatus of claim 17, wherein the at least one processor is configured to:
reduce an amount of the data received over the first backhaul link between the apparatus and the entity based at least in part on the fronthaul airtime utilization in the first frequency band exceeding a first threshold.

23. The apparatus of claim 22, wherein the at least one processor is further configured to:
receive the data over the second backhaul link from the first MLD.

24. The apparatus of claim 17, wherein the at least one processor is configured to:
receive the data over a first backhaul link between the apparatus and a second MLD and an amount of the data received is reduced based at least in part on:
for a most congested band from the first frequency band and the second frequency band,
a difference between a backhaul airtime utilization in the most congested band and a backhaul airtime utilization in a least congested band from the first frequency band and the second frequency band exceeding a fourth threshold, and
the first backhaul airtime utilization in the most congested band exceeding a fifth threshold.

25. The apparatus of claim 17, wherein the at least one processor is further configured to:
receive the data over the second backhaul link from the first MLD, and
wherein the at least one processor is configured to receive the data over the first backhaul link to the first MLD based at least in part on the fronthaul airtime utilization in the first frequency band falling below a first threshold.

26. A method for wireless communication performed, comprising:
receiving a report indicating a fronthaul airtime utilization in a first frequency band of a fronthaul link between a first multi-link device (MLD) and a network entity;
determining a first backhaul airtime utilization in the first frequency band of a first backhaul link between an apparatus and the first MLD, and a second backhaul airtime utilization in a second frequency band of a second backhaul link between the apparatus and the first MLD, the apparatus being in a second MLD; and
selectively transmitting or preventing transmission of data over the first backhaul link to the first MLD based at least in part on the fronthaul airtime utilization, the first backhaul airtime utilization, or the second backhaul airtime utilization.

27. The method of claim 26, wherein the apparatus is a root access point (AP), the network entity is a user equipment (UE), and the first MLD comprises a repeater.

28. The method of claim 26, wherein the report further comprises a second fronthaul airtime utilization in the second frequency band of a second fronthaul link between the first MLD and the network entity or a second network entity, wherein determining the first backhaul airtime utilization in the first frequency band of the first backhaul link and the second backhaul link airtime utilization in the second frequency band of the second backhaul link is based on the first MLD being connected to the network entity or the second network entity with the second fronthaul link.

29. A method for wireless communication, comprising:
transmitting a report indicating a fronthaul airtime utilization in a first frequency band of a fronthaul link between an apparatus and a network entity, the apparatus being in a first MLD; and
selectively receiving or preventing reception of data over a first backhaul link between the apparatus and a second MLD based at least in part on the fronthaul airtime utilization, or a first backhaul airtime utilization in the first frequency band of the first backhaul link, or a second backhaul airtime utilization in a second frequency band of a second backhaul link between the apparatus and the second MLD.

30. The method of claim 29, wherein the apparatus comprises a station (STA) or an AP serving as a repeater or relay, the network entity is a user equipment (UE), and the first MLD comprises a root access point (AP).
